(19) United States
(12) Patent Application Publication
(10) Pub. No.: US 2026/0152160 A1
(43) Pub. Date: Jun. 4, 2026

(54) PRESSURE CONTROL WITH A PUMP

(71) Applicant: Continental Automotive Technologies GmbH, Hannover (DE)

(72) Inventors: Aleksandar Stanojkovski, Kleinostheim (DE); Andreas Neu, Kuhardt (DE)

(73) Assignee: Continental Automotive Technologies GmbH, Hannover (DE)

(21) Appl. No.: 19/121,916

(22) PCT Filed: Oct. 20, 2023
(86) PCT No.: PCT/DE2023/200215

§ 371 Date: Apr. 17, 2025

(30) Foreign Application Priority Data
Oct. 27, 2022 (DE) 10 2022 211 421.3
Feb. 23, 2023 (DE) 10 2023 201 642.7

(51) Int. Cl. B60T 13/68; B60T 13/14

(52) U.S. Cl. CPC B60T 13/686; B60T 13/148

(57) ABSTRACT

A method for controlling a brake system with a plurality of wheel brakes having associated inlet valves and outlet valves and a hydraulic pump for conveying brake fluid is disclosed. To avoid high pressure peaks, the wheel brake with the highest pressure demand is determined as Maxwheel. To adjust a setpoint pressure, the hydraulic pump conveys volumes of brake fluid. In the remaining wheel brakes, the inlet valve of the wheel brakes is open and the outlet valve of the wheel brakes is closed until the setpoint pressure has been reached. Once the setpoint pressure has been reached, the inlet valve is closedTo adjust the setpoint pressure, the inlet valve of the Maxwheel is open and the outlet valve of the Maxwheel is closed. Once the setpoint pressure has been reached, the inlet valve is kept open and the outlet valve is operated in a pulsed manner.

### CROSS-REFERENCE TO RELATED APPLICATIONS

This application is a national stage application, filed under 35 U.S.C. §371, of International Patent Application No. PCT/DE2023/200215, filed on Oct. 20, 2023, which is incorporated by reference herein in its entirety.

### TECHNICAL FIELD

The technical field relates to a method for controlling a brake system having a plurality of wheel brakes with associated inlet valves and outlet valves and a hydraulic pump for conveying brake fluid into the plurality of wheel brakes.

### BACKGROUND

Brake systems such as those described above make it possible to be able to build up a brake pressure and/or to convey back the brake fluid discharged by valve activity independently of a driver by means of the pump. This enables anti-slip control and stability control to be carried out using such brake systems.

If the pump is operated at high speeds, very high system pressures (>250 bar) can occur when the inlet valves are closed, since in such situations the pump is operating in a hydraulically rigid space. Conventional brake systems therefore have burst protection elements in order to prevent such pressure peaks. Otherwise, the brake systems could develop a leak.

Such burst protection elements are associated with high costs, which must be avoided in particular in the case of redundant brake systems. In the case of redundant brake systems, a plurality of pressure sources are available, so that the pump can be used as a fallback level if necessary.

The object of the invention is There remains an opportunity to provide a method and a corresponding brake system that avoid the risk of bursting without expensive burst protection elements.

### SUMMARY

A method for controlling a brake system includes determining a wheel brake with the highest pressure demand. This is referred to as Maxwheel. In order to adjust a setpoint pressure, the hydraulic pump is actuated to actively convey volumes of brake fluid. This can be based on a driver's braking request in a brake-by-wire brake system and/or based on the demand of an assistance system. The pressure control thus provides for the Maxwheel and the remaining wheel brakes to be controlled differently. In the remaining wheel brakes, the inlet valve of the wheel brakes is open and the outlet valve of the wheel brakes is closed until the setpoint pressure has been reached. Once the setpoint pressure has been reached, the inlet valve is closed so that the pressure does not rise further. In the Maxwheel, in order to adjust the setpoint pressure, the inlet valve is likewise open and the outlet valve of the Maxwheel is closed until the setpoint pressure has been reached. However, as soon as the setpoint pressure has been reached, the inlet valve is kept open and the outlet valve is operated in a pulsed manner. This provides a pressure control in which the volume conveyed by the pump can flow off via an outlet valve, thereby preventing a sharp pressure increase. The inlet valves may be check valves, which are each connected in parallel.

In one embodiment, the inlet valve of the Maxwheel is kept open when de-energized or partially energized. When partially energized, the inlet valve is moved to a position in which it provides a flow resistance that is greater than in a de-energized state, but smaller than in the closed state. In this state, the inlet valve can still prevent a sharp pressure increase, in particular pressure peaks, and also causes the pump to slow down.

In another embodiment, the inlet valve of the Maxwheel is brought into the partially energized open state when two other inlet valves are already closed and a third inlet valve is simultaneously closed. This builds up an increased counter pressure at the pump outlet early on, which slows down the pump.

In another embodiment, the holding current at the inlet valve of the Maxwheel is selected such that the inlet valve is pressed open at a predetermined differential pressure, for example at a differential pressure of 20 bar.

In another embodiment, during the pressure control, the pressure side of the pump is connected only to the inlet valves of the wheel brakes and to at least one closed separation valve. This eliminates the need for expensive burst elements.

In another embodiment, the outlet valve is operated in a pulsed manner by a pulse width controller with a predetermined opening ratio, which is set in such a manner that the pressure of the Maxwheel corresponds to the setpoint pressure of the Maxwheel. The current system pressure, known pressure volume characteristics, the target pressure and the known aperture factors of the outlet valves enable the outgoing volume flow to be controlled over the switching duration. For example, a period of 5 ms can be used in this case, which is set with a resolution of 1 ms. The setting of the pulse width modulation means that the pressure-dependent volume flow is set via the outlet valve, in particular into a pressure-free brake fluid reservoir. Thus, the pressure in the Maxwheel can be precisely controlled via the pulse width modulation.

In another embodiment, in order to release pressure at the Maxwheel, the outlet valve thereof is opened while the inlet valve is still open. This also avoids a hydraulically rigid space and thus pressure peaks during the pressure release.

In one embodiment, in order to release pressure, the pump speed is additionally reduced, thereby minimizing the volume of brake fluid flowing in the circuit and supporting the pressure release. Alternatively or in addition, the inlet valve is partially energized, thereby likewise reducing the volume flow.

A hydraulic brake system for motor vehicles having a control device that is configured to carry out one of the above methods is also disclosed.

A computer program product that is designed in such a manner that it, when executed in a control device, carries out one of the above methods, is also disclosed.

Further features, advantages and possible applications also result from the description below of exemplary embodiments and the drawings. All of the features described and/or pictorially depicted are associated with the subject matter of the disclosure both individually and in any combination, also independently of their combination in the claims or the back-references thereof.

### BRIEF DESCRIPTION OF THE DRAWINGS

FIG. 1 schematically shows a brake system according to one exemplary embodiment,

FIG. 2 shows an exemplary pressure curve without the method, and

FIG. 3 shows an exemplary pressure control using the method according to one exemplary embodiment.

### DETAILED DESCRIPTION

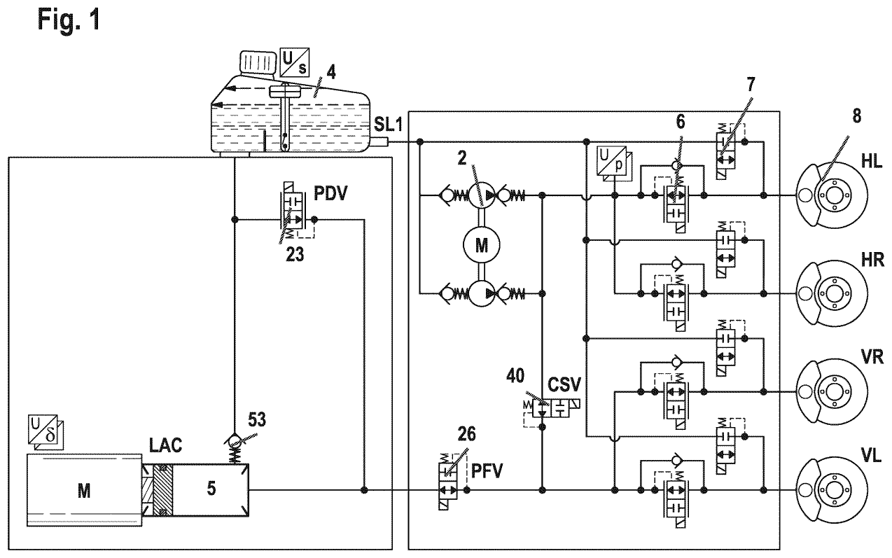

FIG. 1 illustrates a redundant hydraulic brake system for motor vehicles. According to the example, the brake system is designed for actuating four hydraulically actuatable wheel brakes 8; an extension to more wheel brakes is easily possible. According to the example, the wheel brakes (HL, HR) are associated with the rear axle and the wheel brakes (VL, VR) are associated with the front axle of the vehicle.

The brake system includes a first assembly, which is configured according to the example as a first electro-hydraulic brake control unit with a valve block and a first electronic control device, and a second assembly, which is configured according to the example as a second electro-hydraulic brake control unit with a valve block and a second electronic control device.

A pressure medium reservoir 4 with two chambers is arranged on the first assembly, wherein a first reservoir port is associated with the first chamber and a second reservoir port is associated with the second chamber.

A first electrically actuatable pressure source 5 is arranged in the first assembly.

A second electrically actuatable pressure source 2 and wheel-specific brake pressure modulation valves, which are configured as an electrically actuatable inlet valve 6 and an electrically actuatable outlet valve 7 for each wheel brake 8, are arranged in the second assembly.

The first pressure source 5 and the second pressure source 2 are connected on the pressure side to a brake supply line, to which the four inlet valves 6 are connected. All four wheel brakes 8 can thus be actuated with the first pressure source 5 or with the second pressure source 2.

An electrically actuatable circuit separation valve 40 is arranged in the brake supply line, and therefore, when the circuit separation valve 40 is closed, the brake supply line is separated into a first line portion, to which the inlet valves 6 and/or the wheel brakes 8 of the rear axle are connected, and a second line portion, to which the inlet valves 6 and/or the wheel brakes 8 of the front axle are connected. The second pressure source 2 is hydraulically connected to the first line portion, and the first pressure source 5 is hydraulically connected to the second line portion. When the circuit separation valve 40 is closed, the brake system is thus separated or divided into two hydraulic brake circuits I and II. In this case, in the first brake circuit I, the pressure source 2 is still connected to only the wheel brakes 8 of the rear axle (via the first line portion) and, in the second brake circuit II, the first pressure source 5 is still connected to only the wheel brakes 8 of the front axle (via the second line portion). The circuit separation valve 40 is advantageously configured to be open when de-energized.

As already mentioned, the brake system includes, for each hydraulically actuatable wheel brake 8, an inlet valve 6 and an outlet valve 7, which are hydraulically connected to one another in pairs via central ports and are each connected to a hydraulic wheel port of the second assembly, to which the corresponding wheel brake 8 is connected. A check valve that opens toward the brake supply line is connected in parallel with each of the inlet valves 6. The output ports of the outlet valves 7 are connected to the pressure medium reservoir 4, or the second chamber thereof, via a common return line. The input ports of all the inlet valves 6 can be supplied via the brake supply line (i.e., when the circuit separation valve 40 is open) with a pressure that is provided by the first pressure source 5 or, for example in the event of failure of the first pressure source 5, by the second pressure source 2.

The first electrically controllable pressure source 5 of the valve block is configured as a hydraulic cylinder-piston arrangement (or a single-circuit electro-hydraulic actuator (linear actuator)), the piston of which can be actuated, in particular advanced and retracted, in order to build up and release pressure in a pressure chamber, by a schematically indicated electric motor with the interposition of a likewise schematically illustrated rotary-translatory gear mechanism. The piston delimits the pressure chamber of the pressure source 5. A rotor position sensor, which detects the rotor position of the electric motor and is indicated merely schematically, is provided for actuating the electric motor.

A system pressure line portion is connected to the pressure chamber of the first electrically controllable pressure source 5. By means of the line portion, the pressure source 5, or the pressure chamber thereof, is connected to a hydraulic port of the first assembly, the hydraulic port being connected to a hydraulic port of the second assembly via a hydraulic connecting element. This connection represents the only hydraulic pressure connection, in particular the only hydraulic connection, between the first and the second assembly. This is a hydraulic connection for transmitting a brake pressure for actuating the wheel brakes 8.

The pressure chamber is connected, irrespective of the actuation state of the piston, to the pressure medium reservoir 4 via a (replenishment) line. A check valve 53, which is closed toward the pressure medium reservoir 4 and is connected to the second chamber, is arranged in the line. An electrically switchable valve 23 forms a further connection to this line, which is connected to the output port of the linear actuator 5. According to the example, the cylinder-piston arrangement 5 does not have any breather holes.

According to the example, the second electrically controllable pressure source 2 of the second assembly is configured as a dual-piston pump, the two pressure sides of which are connected to one another. The suction sides are connected to the return line and thus to the pressure medium reservoir 4. The pressure sides are connected to the first line portion of the brake supply line.

According to the example, in addition to the pressure source 2 and the brake pressure modulation valves 6, 7, an electrically actuatable isolation valve 26, which is advantageously open when de-energized, is arranged in the second assembly. The isolation valve 26 is hydraulically arranged between the port and the second line portion of the brake supply line. Thus, the first pressure source 5 is separably connected to the second line portion, or the brake supply line, via the isolation valve 26.

According to the example, the brake system includes a pressure sensor, which is thus associated with the second pressure source 2, in the brake circuit I. This is advantageous for protection against bursting when the circuit is divided, that is to say when the circuit separation valve 40 is closed. However, the pressure sensor can also be arranged in the brake circuit II, or a second pressure sensor can be provided, so that each of the two brake circuits I and II can be directly monitored by means of a pressure sensor.

According to the example, the brake system includes, for leakage monitoring purposes, a level-measuring device for determining a pressure medium level in the pressure medium reservoir 4.

An electronic control device is associated with each valve block. Each electronic control device includes electrical and/or electronic elements (for example, microcontrollers, power modules, valve drivers, other electronic components, etc.) for actuating the electrically actuatable components of the associated valve block, and optionally the associated sensors. The valve block and electronic control device are advantageously configured in a known manner as an electro-hydraulic unit.

The first electronic control device actuates the first pressure source 5. According to the example, the first pressure source 5 is supplied with energy (from a first electrical energy source) via the first electronic control device.

The second electronic control device actuates the second pressure source 2. According to the example, the second pressure source 2 is supplied with energy (from a second electrical energy source) via the second electronic control device.

According to the example, the first pressure source 5 can be or is actuated exclusively by the first electronic control device, and the second pressure source 2 can be or is actuated exclusively by the second electronic control device.

The brake system has a primary pressure source 5 and a secondary pressure source 2, each of which is electrically operated by an ECU and has a suction port and a pressure port. No brake fluid can flow into the pressure port of the secondary pressure source 2, even in the de-energized state. The primary pressure source 5 is preferably a linear actuator with a replenishment check valve 53 and the secondary pressure source 2 is a piston pump. The secondary pressure source 2 can preferably generate a higher pressure than the primary pressure source 5.

The suction sides of the two pressure sources 2, 5 are connected to a pressure medium reservoir 4, preferably in each case to at least one of two separate chambers.

The pressure side of the primary pressure source 5 is connected to a primary circuit node via an electromagnetic valve 26, also referred to as pressure activation valve or isolation valve.

The pressure side of the secondary pressure source 2 is connected directly (without an interposed valve) to a secondary circuit node. The two circuit nodes are connected to one another via an electromagnetic valve 40, also referred to as circuit dividing valve.

In normal operation, the pressure in the wheel brakes is built up by the primary pressure source 5. The pressure is released into the primary pressure source 5. The pressure is wheel-specifically modulated by the inlet and outlet valves as required. If necessary, the isolation valve 26 is closed so that the primary pressure source 5 can replenish additional volume.

If a particularly high volume flow rate is demanded, both pressure sources 5 and 2 operate simultaneously in parallel. If a particularly high pressure is demanded, the isolation valve 26 is closed and the secondary pressure source 2 increases the pressure beyond the pressure of the primary pressure source 5. Outside of braking operations, atmospheric pressure equalization can be permanently ensured via the separation valve 23 and isolation valve 26.

In the event of a leak in the brake system, the circuit separation valve 40 is closed and the system is thus divided into two independent brake circuits I and II.

The isolation valve 26 may be actuated by the secondary ECU. The following description of operation in the event of a fault relates to this valve association.

If the primary system, in particular the primary ECU or the voltage supply thereof, fails electrically, the secondary ECU closes the isolation valve 26 in order to build up pressure via the secondary pressure source 2. Pressure is released via the isolation valve 26 or via the outlet valves 7. The inlet and outlet valves may be actuated by the secondary ECU, so that the pressure can be wheel-specifically modulated.

If the secondary system, in particular the secondary ECU or the voltage source thereof, fails electrically, the pressure is built up and released via the primary pressure source 5 as in normal operation. Wheel-specific pressure control has to be dispensed with, but joint modulation of the wheel pressures remains possible in order to prevent the vehicle being destabilized by locking wheels.

In the above operating modes, the piston pump 2 is therefore the pressure source for at least two wheel brakes. In this instance, the pressure side of the pump 2, in addition to the inlet valves 6 of the wheel brakes 8, is partially connected only to a closed valve, i.e., the circuit separation valve 40 or activation valve 26.

A wheel pressure controller (WPC) can keep a higher admission pressure away from the wheel by closing the inlet valve. In the case of higher admission pressure, pressure can be built up at the wheel by opening the respective inlet valve. In order to release pressure at the wheel, the outlet valve is opened when the inlet valve is closed. Simultaneously opening the inlet valve and outlet valve (hydraulic short circuit) is not part of the WPC.

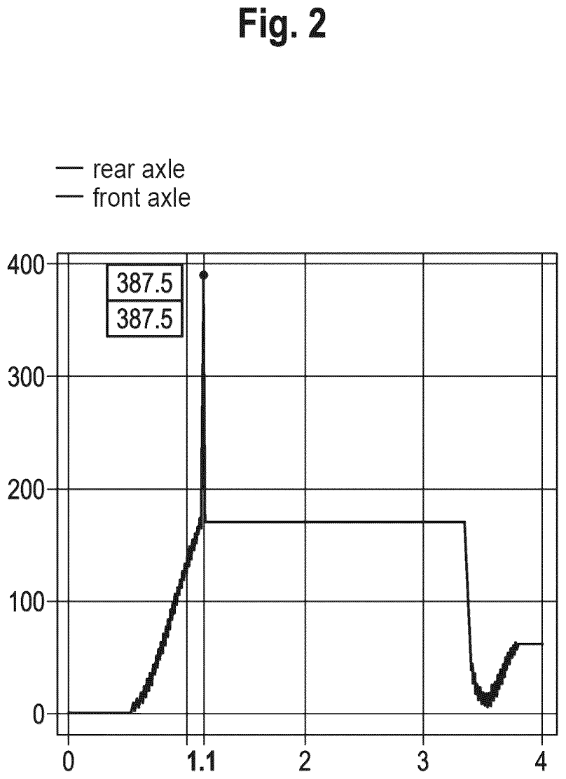

If all the inlet valves are closed, the pump 2 is operating against a hydraulically rigid space, which could result in high pressure peaks. FIG. 2 shows the system pressure curve when all the inlet valves are closed in the case of a pressure build-up ramp by the pump at 150 bar. The resulting system pressure exceeds 380 bar. The pressure control of the wheel brake 8 is therefore carried out with the highest setpoint pressure in such a manner that the inlet valve 6 remains at least partially open and instead the outlet valve 7 of the wheel brake is controlled by pulse width modulation in order to adjust the setpoint pressure.

When pressure is built up via pump 2 (referred to here as pump operation), the activation valve PFV 26 is closed. In pump operation, pressure can be released in the system pressure only by opening an outlet valve 7. If, in order to keep the rigidity in the system pressure chamber low and to avoid pressure peaks, simply an inlet valve is kept open, then, without the method according to the invention, the pressure at this wheel can be set only very imprecisely via the pump, as a result of which a poorer braking distance performance is achieved. If, alternatively, in the case of four closed inlet valves, the holding current thereof is selected in pump operation in such a manner that system pressure peaks result in the inlet valves 6 being pressed open, the volume flow into the respective wheel brake 8 can be corrected only via a detected wheel slip. This likewise results in a poorer braking distance performance. The method disclosed herein enables, in spite of the avoidance of pressure peaks, precise pressure control and thus a better braking distance performance to be achieved.

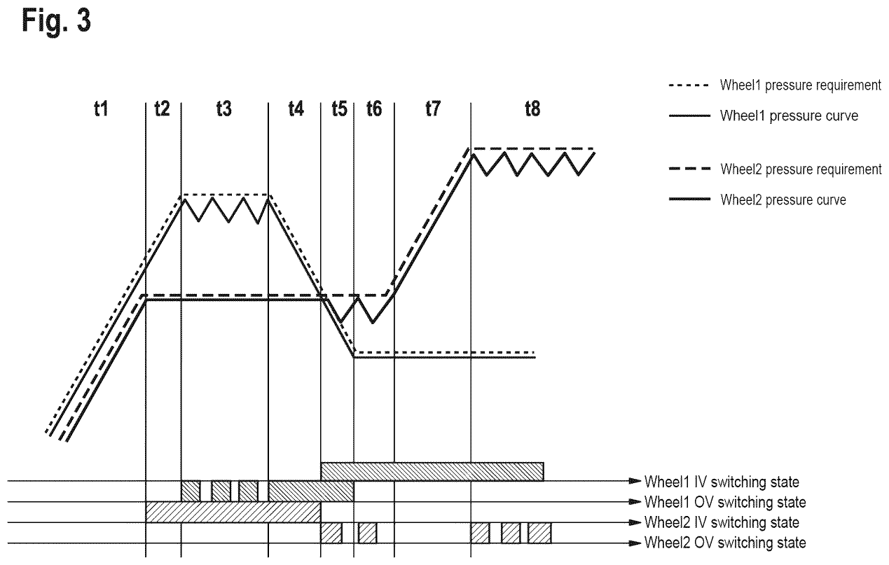

FIG. 3 shows, by way of example, the pressure control principle at two wheels. The pressure demand of one wheel is shown by a short dashed line (initially the upper line) and that of the other wheel is shown by a longer dashed line. Alongside these are the respective actual pressure curves. The upper part of the image shows the pressure curves and the lower part shows the associated inlet and outlet valve states over time. The individual time phases are designated by tx.

During the pressure control shown, the hydraulic pump 2 continuously conveys volumes of brake fluid, while the activation valve 26 is closed.

A marked switching state of an inlet valve means it is active, i.e. hydraulically closed, otherwise it is open. A marked switching state of an outlet valve means it is active, i.e., hydraulically open, otherwise it is closed.

In phase t1, a common build-up of pressure takes place.

In Phase t2, the no longer increasing pressure demand at Wheel2 is met by closing the inlet valve 6 at Wheel2. Since the pressure demand at Wheel1 continues to increase, the inlet valve 6 thereof remains open and the pump flow results in the pressure increase at Wheel1.

In Phase w3, the pressure demand at Wheel1 does not increase any further. This pressure demand is then met by pulsing the outlet valve of Wheel1 with the inlet valve open. Since the pump 2 will continue to convey, the pressure curve at this wheel is a result of pressure being built up by pump 2 and pressure being released by opening the outlet valve. The outlet valve can be actuated by a plurality of short actuation pulses or a few long actuation pulses.

In Phase t4, the pressure release demanded at Wheel1 is achieved by opening the outlet valve for a longer period of time. In addition, the pump voltage can be reduced in this phase.

In Phase t4, at this point, the pressure demands of both wheels intersect. The Maxwheel changes and accordingly one inlet valve 6 is closed and the other is opened. In order to avoid system pressure peaks, the inlet valves are actuated in such a manner that there is no overlap of closed inlet valves 6.

The disclosed subject matter is also applicable if the circuit separation valve 40 is closed instead of the activation valve 26 and if normal braking (all wheel pressure requests are equal) and not just ABS (different wheel pressure requests) is used during pump operation.

Variants are described below. At the wheel with the maximum brake pressure, Maxwheel for short, the inlet valve 6 cannot be de-energized, but instead partially energized. This makes it possible to provide a small amount of hydraulic resistance and to avoid crossflow if the outlet valve at this wheel needs to release too much pressure. At the Maxwheel, a low holding current is therefore applied to the inlet valve 6. Advantageously, such partial closing of the inlet valve 6 at the Maxwheel takes place when two inlet valves 6 have already had to be closed in order to hold or release pressure at the wheels and also the third inlet valve is simultaneously closed.

The holding current at the Maxwheel can be selected in such a manner, for example, as to cause the inlet valve to be pressed open at a differential pressure of 20 bar. As a result, the Maxwheel inlet valve provides a higher hydraulic resistance to the pump, which in turn results in stronger braking behavior of the pump and improves the pressure setting precision.

The outlet valves are able to release greater amounts of pressure at higher pressures. Therefore, when pressure is released at the Maxwheel, the wheel pressure may fall below the pressure value of another wheel. This leads to another advantage: A partially closed inlet valve at the Maxwheel prevents crossflow via the check valves of the other inlet valves.

The disclosed subject matter makes it possible to eliminate the need for complex burst protection elements while continuing to enable highly precise pressure setting.

1-11. (canceled)

12. A method for controlling a brake system having a plurality of wheel brakes with associated inlet valves and outlet valves, and a hydraulic pump for conveying brake fluid to the plurality of wheel brakes, said method comprising:
determining the wheel brake of the plurality of wheel brakes with the highest pressure demand and assigning the wheel brake with the highest pressure demand as Maxwheel and the other wheel brakes as the remaining wheel brakes;
adjusting a setpoint pressure in the remaining wheel brakes by opening the inlet valve and closing the outlet valve until the setpoint pressure is reached, and closing the inlet valve when the setpoint is reached; and
adjusting a setpoint pressure in the Maxwheel by opening the inlet valve and closing the outlet valve until the setpoint pressure is reached, and keeping open the inlet valve and pulsing the outlet valve when the setpoint is reached.

13. The method for controlling a brake system as claimed in claim 12, further comprising keeping open the inlet valve of the Maxwheel when de-energized or partially energized.

14. The method for controlling a brake system as claimed in claim 13, further comprising bringing the inlet valve of the Maxwheel into the partially energized open state when two other inlet valves are already closed and a third inlet valve is simultaneously closed.

15. The method for controlling a brake system as claimed in claim 13, further comprising selecting the holding current at the inlet valve of the Maxwheel such that the inlet valve is pressed open at a predetermined differential pressure.

16. The method for controlling a brake system as claimed in claim 12, wherein during the pressure control, the pressure side of the pump is connected only to the inlet valves of the wheel brakes and to at least one closed separation valve.

17. The method for controlling a brake system as claimed in claim 12, further comprising operating the outlet valve in a pulsed manner with a pulse width controller with a predetermined opening ratio, which is set in such a manner that the pressure of the Maxwheel corresponds to the setpoint pressure of the Maxwheel.

18. The method for controlling a brake system as claimed in claim 12, further comprising opening the outlet valve while the inlet valve is open to release pressure.

19. The method for controlling a brake system as claimed in claim 12, further comprising reducing the speed of the hydraulic pump to release pressure.

20. The method for controlling a brake system as claimed in claim 12, further comprising partially energizing the inlet valve to release pressure.

21. A hydraulic brake system for motor vehicles, comprising:
a plurality of wheel brakes with associated inlet valves and outlet valves;
a hydraulic pump for conveying brake fluid to the plurality of wheel brakes; and a control device configured to
determine the wheel brake of the plurality of wheel brakes with the highest pressure demand and assigning the wheel brake with the highest pressure demand as Maxwheel and the other wheel brakes as the remaining wheel brakes,
adjusting a setpoint pressure in the remaining wheel brakes by opening the inlet valve and closing the outlet valve until the setpoint pressure is reached, and closing the inlet valve when the setpoint is reached, and
adjusting a setpoint pressure in the Maxwheel by opening the inlet valve and closing the outlet valve until the setpoint pressure is reached, and keeping open the inlet valve and pulsing the outlet valve when the setpoint is reached.
